(19) United States
(12) Patent Application Publication
(10) Pub. No.: US 2002/0126395 A1
(43) Pub. Date: Sep. 12, 2002

(54) Panoramic image acquisition device

(76) Inventors: Sajan Gianchandani, Paris (FR); Alexandre Leroy, Sannois (FR)

Correspondence Address: Thomas Christenbury, Schnader Harrison Segal & Lewis LLP, Suite 3600, 1600 Market Street, Philadelphia, PA, 19103, US

(21) Appl. No.: 10/082,922

(22) Filed: Feb. 26, 2002

Related U.S. Application Data
(63) Continuation of application No. PCT/FR00/02606, filed on Sep. 20, 2000.

(30) Foreign Application Priority Data
Mar. 22, 2000 (FR) 00/03672

(51) Int. Cl. G02B 13/06

(52) U.S. Cl. 359/725

(57) ABSTRACT

A panoramic image acquisition device including at least one primary reflector provided with an outer primary surface which is at least partially reflective to reflect an image towards at least one image sensor, wherein the primary reflector has a concave conical primary surface.

### RELATED APPLICATION

This is a continuation of International Application No. PCT/FR00/02606, with an international filing date of Sep. 20, 2000, which is based on French Patent Application No. 00/03672, filed Mar. 22, 2000.

### FIELD OF THE INVENTION

This invention concerns the field of panoramic image acquisition for visualizing an environment over 360°.

### BACKGROUND

A panoramic image is a two-dimensional image which enables visualization of the environment situated in an entire perimeter around a specific point with a three-dimensional effect. This type of image is very useful for visualizing a landscape from a particular point or for visualizing the interior space of a room. When the image is acquired with a video camera, the device also enables implementation of surveillance videos.

Panoramic image acquisition devices are already known, such as in WO-A-99/30197, which pertains to an omnidirectional device that can capture the image of a scene from a single point of view. This device comprises an essentially parabolic reflector means placed to reflect orthographically the principal electromagnetic radiation rays emitted by a scene. The reflector means has a focal point which coincides with a single point of view of a omnidirectional device, including a essentially parabolic reflector means. This device also comprises one or more image sensors placed to receive a principal rays of the electromagnetic radiation reflected orthographically by a parabolic reflector, which enables capture of the image of a scene.

The major disadvantage of this device is that:

part of the visual field of the paraboloid form is hidden by the image sensor;

the reflector means “sees” part of the image sensor which necessarily will appear on the final image and, thus, have an impact on the quality and realism of the view;

the visual field is essentially centered downwardly, whereas human vision is essentially centered horizontally;

it is difficult to protect the reflective surface against jolts and rays without complete or partial hiding of its visual field; the only solution is to select a very hard and, thus, very expensive fabrication material;

the device does not allow visualization of the entirety of the environment because the visual field is only very partial.

It would, therefore, be advantageous to provide a panoramic image acquisition device which makes it possible to:

hide the image sensor;

acquire an image recentered horizontally and, thus, very close to human vision;

to house the device in a protective housing which is hidden in the acquired image;

to acquire an image enabling visualization of the entirety of the environment using a device comprising a complete visual field; and

implement image capturing.

### SUMMARY OF THE INVENTION

This invention relates to a panoramic image acquisition device including at least one primary reflector provided with an outer primary surface which is at least partially reflective to reflect an image towards at least one imate sensor, wherein the primary reflector has a concave conical primary surface.

### BRIEF DESCRIPTION OF THE DRAWINGS

Better comprehension of the invention will be obtained from the description below, presented strictly for explanatory purposes, of multiple modes of implementation of the invention with reference to the attached figures:

FIG. 1 shows an image acquisition device of the prior art;

FIG. 2 shows the visual field of the device of FIG. 1;

FIGS. 3 and 4 show, respectively, a front view and a top view of the primary reflector means of the device according to aspects of the invention;

FIG. 5 shows the visual field of the device of FIGS. 3 and 4;

FIG. 6 shows the visual field of the device according to aspects the invention when the primary reflector means has a base with a return;

FIG. 7 shows a sectional view of an attachment housing of the device according to aspects of the invention on an optical system of an image sensor;

FIG. 8 shows a version of the invention with a primary reflector means and a secondary reflector means positioned back to back;

FIG. 9 shows an embodiment of the invention with a primary reflector means and a secondary reflector means positioned face to face;

FIG. 10 shows an embodiment of the invention with a primary reflector means and a secondary reflector means positioned back to back with the image sensor positioned between them;

FIG. 11 shows an embodiment of the invention with a primary reflector means and a secondary reflector means positioned face to face with the image sensor positioned between them; and

FIG. 12 shows the principle for determination of the principal parameters of an embodiment of the device according to aspects of the invention.

### DETAILED DESCRIPTION

It will be appreciated that the following description is intended to refer to specific embodiments of the invention selected for illustration in the drawings and is not intended to define or limit the invention, other than in the appended claims.

As sometimes hereinafter stated, a “cone” is a regular surface whose generator passes through a fixed point, the vertex. Similarly, a “concave cone” is a cone whose generator exhibits a curve in the direction of the cone's axis.

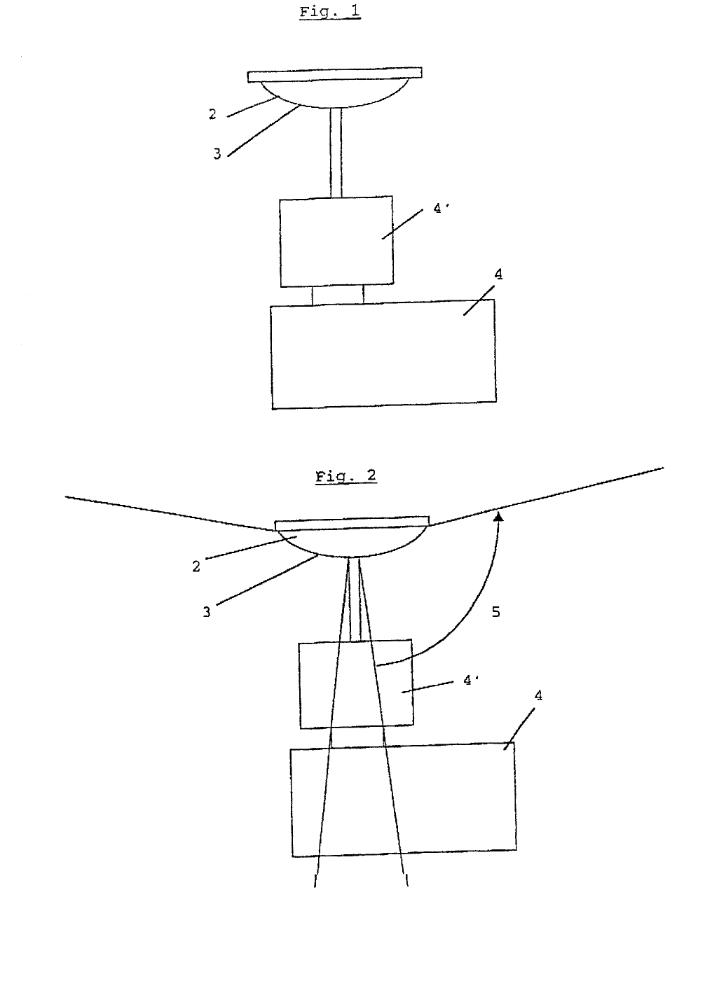

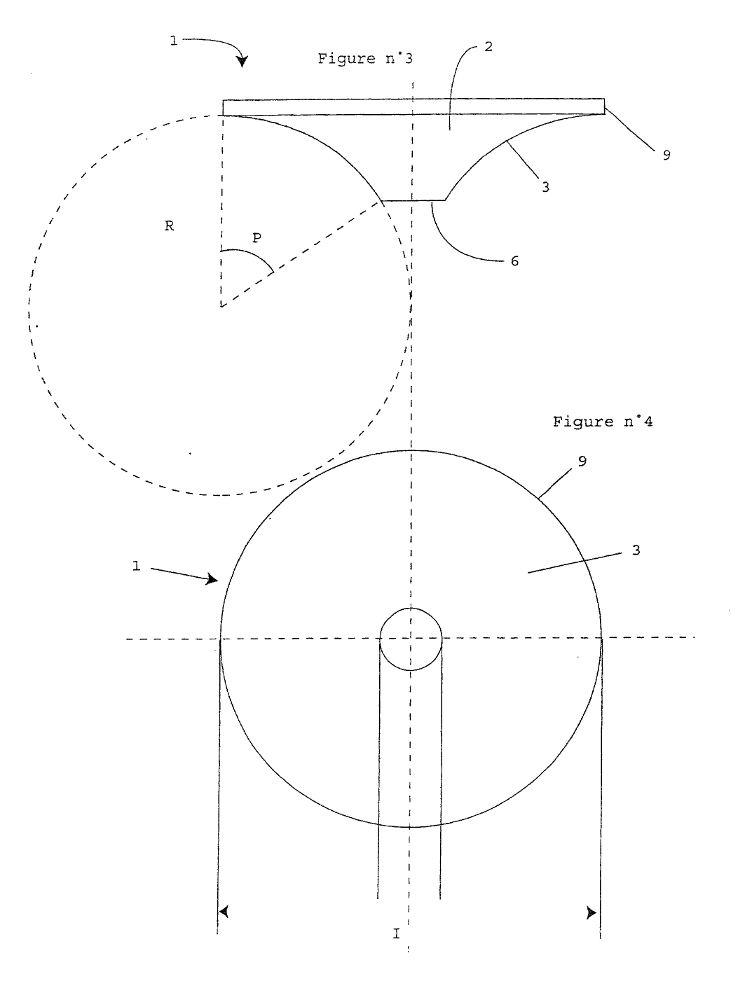

FIGS. 1 and 2 show a panoramic image acquisition device of the prior art comprising a primary reflector means (2) provided with a primary outer reflective surface (3) to reflect an image towards an image sensor (4) such as a photographic or video camera. The primary reflector means (2) is positioned in the optical axis of the image sensor (4) and its optical system (4′). The primary surface (3) is convex and has a parabolic or semicircular form. Part of the visual field (5) of the paraboloid form is hidden by the optical system (4′) of the image sensor (4).

The primary reflector means (2) “sees” part of the image sensor (4) and the optical system (4′), which will necessarily be visible on the final image and, thus, will have an impact on the quality and realism of the view.

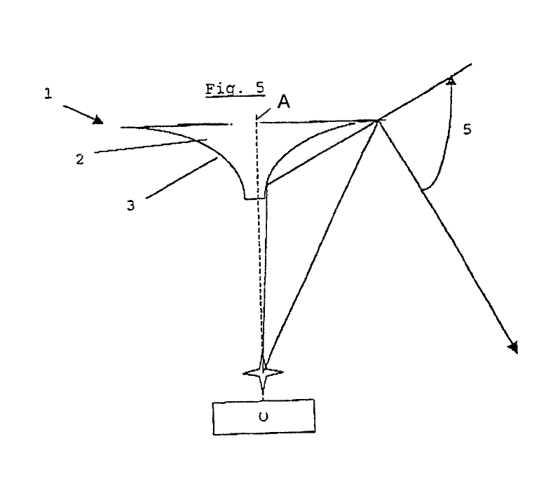

The device according to the invention, shown in FIGS. 3 and 4, is a panoramic image acquisition device (1) comprising at least one primary reflector (2) provided with an outer primary surface (3) which is at least partially reflective to reflect an image towards at least one image sensor (4) such as a photographic or video camera.

The primary surface (3) preferably constitutes a mirror transmitting all of the waves but it can also possibly comprise a filter to prevent reflection of certain waves. The device according to the invention is characterized in that the primary reflector (2) has a concave conical primary surface (3), i.e., curved towards its central axis.

According to variants of the invention, the conical surface is generated by an essentially parabolic generator or by a generator which is essentially an arc of a circle or by an essentially elliptical generator, depending on the desired image characteristics.

The section viewed from below is thus a circle or an ellipse. For example, the primary surface (3) can be a conical surface of an arc of a circle with a radius R of approximately 60 millimeters for an angle P of approximately 56.5° and the outside diameter I can be approximately 120 millimeters.

FIG. 5 shows the visual field (5) of a fictional observer O by means of the device according to the invention. By means of the concave conical primary surface (3), the point of origin of the visual angle is displaced from the proximal end of the reflector means towards its distal end. Thus, the primary surface (3) does not reflect the observer o or the image sensor positioned in its place. The optical system of the image sensor is, thus, outside of the visual field (5) and the primary surface (3) can be placed in a protective device also located outside of the visual field (5).

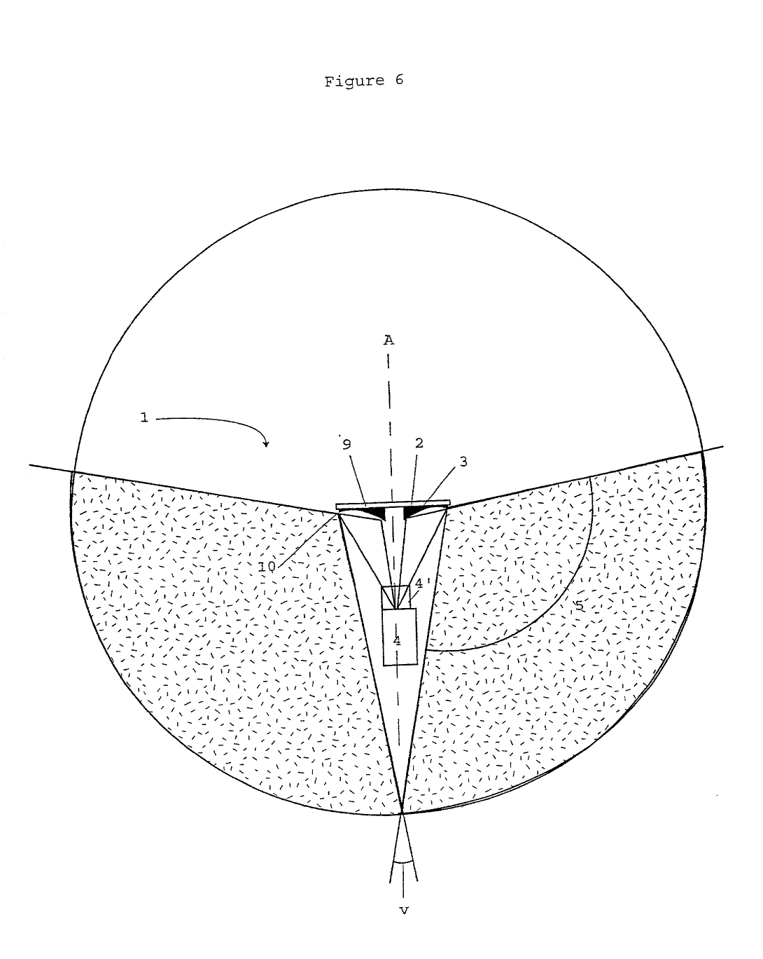

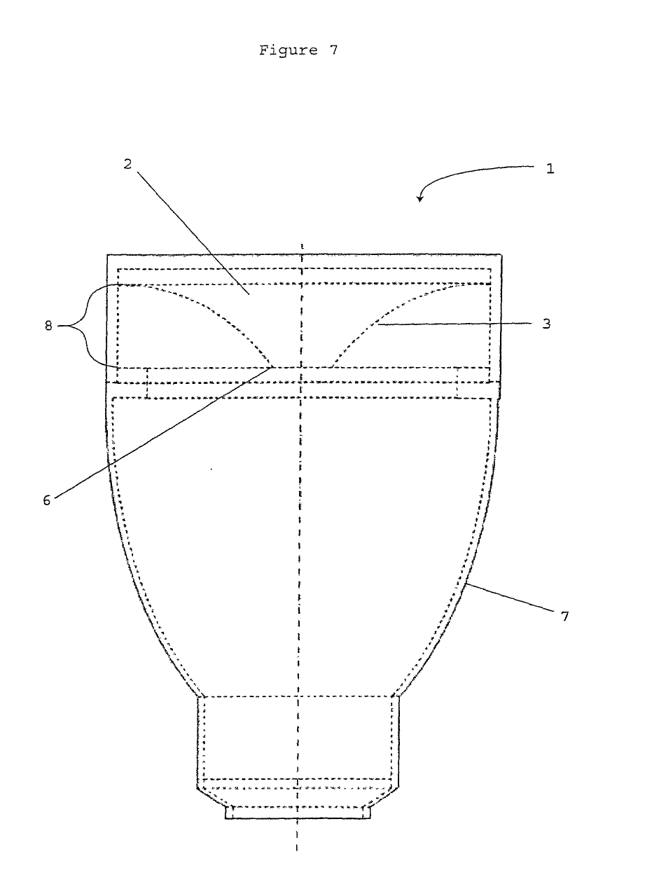

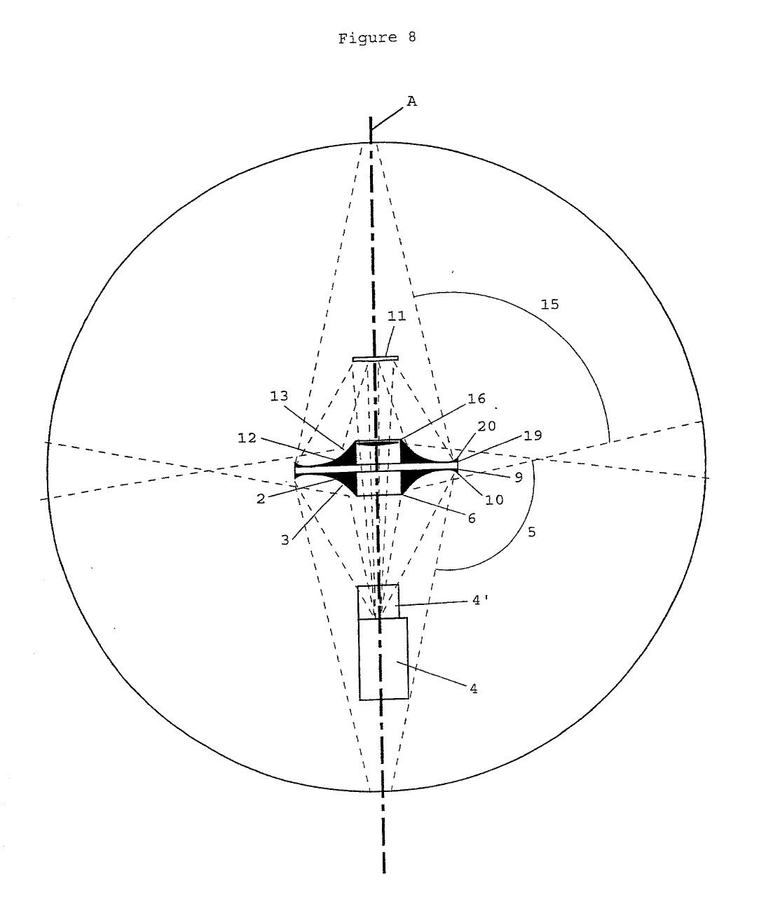

In one version of the invention, the primary reflector (2) is in the form of a cone with a base (9) having a return (10) as shown in FIG. 6 to enable capturing the field of vision V located behind the image sensor (4). The primary reflector (2) can be in the form of a cone whose vertex (6) is truncated and the device (1) can have an attachment element located at least at the level of the vertex (6) to allow attachment to the image sensor (4).

This attachment element can be constituted, for example, by a rod positioned in the axis A of the optical system of the device (1) and attached against the vertex (6).

This attachment element can also be constituted, for example, by a housing (7) comprising a screw thread intended to cooperate with the screw thread normally provided at the end of the optical system (4′) of the image sensor (4), with this housing also being attached against the vertex (6) as shown in FIG. 7.

In this base version, said primary reflector means (2) is positioned in the axis of the optical system of the image sensor (4) either vertically or horizontally, or possibly inclined.

In a preferred embodiment, the image acquisition device (1) comprises at least one transmission surface (11, 21), which is at least partially reflective, coaxial with the primary reflector (2), to enable inversion of the position of the image sensor (4) on the optical axis A.

In that embodiment, the device (1) comprises a secondary reflector means (12) provided with a secondary outer surface (13) having the form of a cone which is at least partially reflective and concave, essentially coaxial with the primary reflector (2), and whose secondary vertex (16) is truncated and recessed. The primary reflector (2) and the secondary reflector (12) can be identical and positioned symmetrically in relation to a plane perpendicular to the optical axis A of the device (1). The primary reflector (2) and the secondary reflector (12) can be positioned face to face, i.e., base (9) against base (19), as shown in FIG. 8.

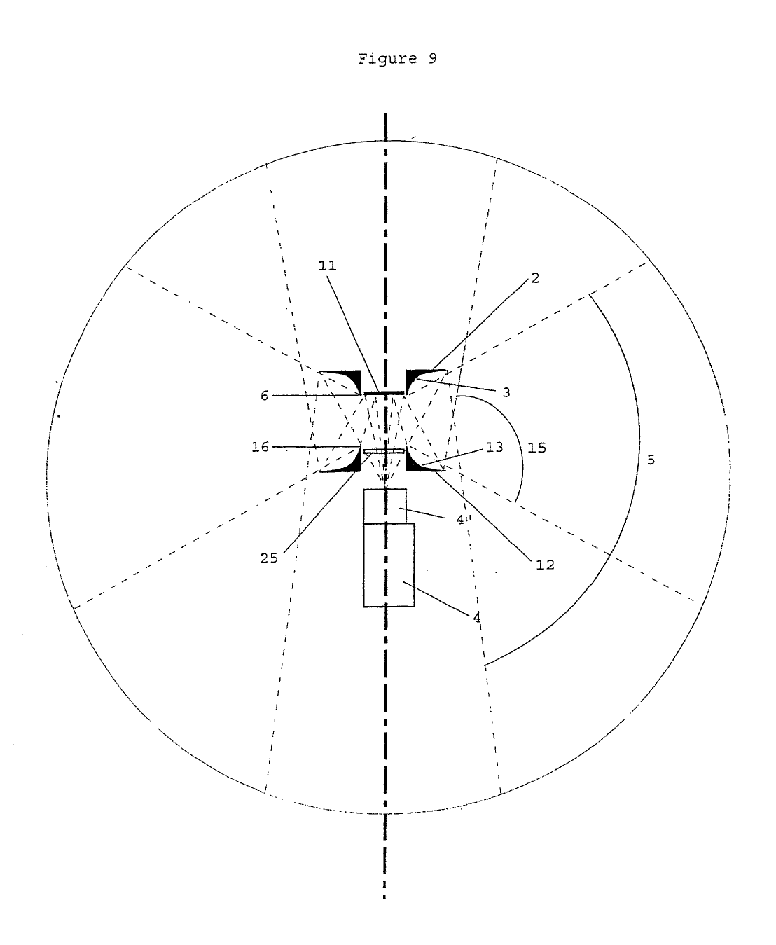

The primary reflector (2) and the secondary reflector (12) can be positioned back to back, i.e., with the primary surface (3) facing the secondary surface (13), as shown in FIG. 9. The transmitting surface (11) is then planar or possibly concave and the vertex (16) of the secondary reflector (12) preferably comprises an at least partially transparent surface (25).

In these two preceding embodiments, the image sensor (4) is positioned in the optical axis of the device (1), but it can also be envisaged to position the image sensor (4) between the primary reflector (2) and the secondary reflector (12), essentially perpendicular to the optical axis A of the device (1).

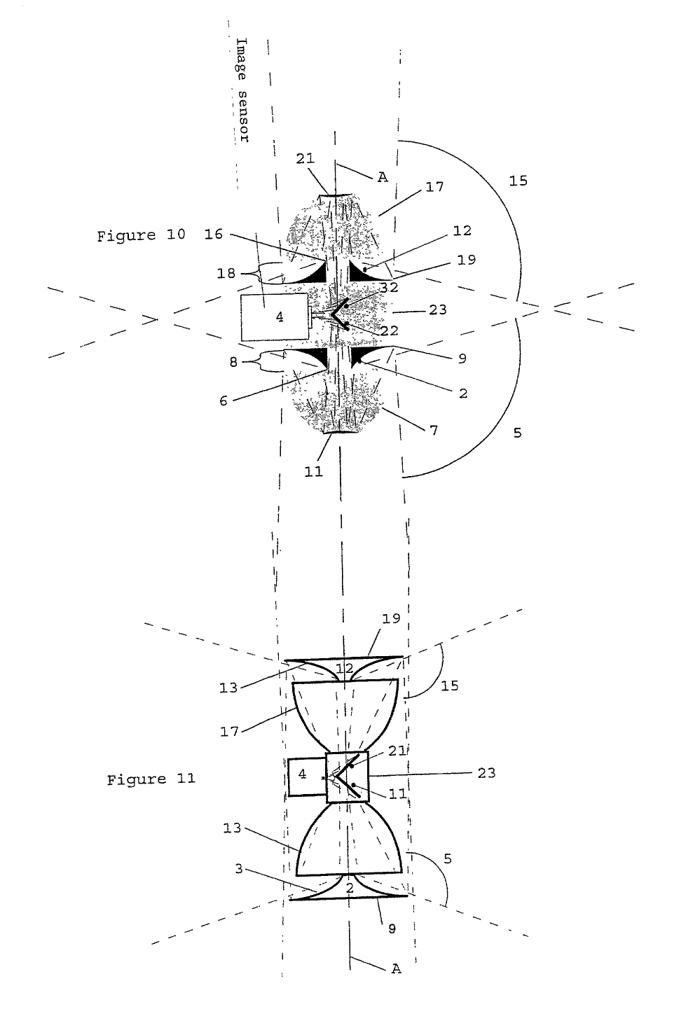

FIG. 10 shows, for example, a version of the invention in which the primary reflector (2) and the secondary reflector (12) are positioned back to back and the image sensor (4) is placed between them.

The primary reflector (2) and the secondary reflector (12) then each comprise respectively a transmitting surface (11, 21) of order 1, coaxial respectively with the primary reflector (2) and the secondary transmitting (12), as well as a transmitting surface (22, 32) of order 2 which is inclined in relation to the optical axis A for transmitting the images which have passed through the respective vertices (6, 16) towards the image sensor

The order 1 transmitting surfaces (11, 21) and the order 2 transmitting surfaces (22, 32) are not necessarily planar, but can have a calculated deformation.

FIG. 11 shows an embodiment of the invention in which the primary reflector (2) and the secondary reflector (12) are positioned face to face and the image sensor (4) is placed between them. The primary reflector (2) and the secondary reflector (12) then each comprise respectively a transmitting surface (11, 12) which is inclined in relation to the optical axis A to transmit the images towards the image sensor (4). The transmitting surfaces (11, 21) are not necessarily planar, but can have a calculated deformation.

The reflector(s) (2, 12) is (are) preferably located in a protective housing (7, 17) having at least one window (8, 18) which is at least partially transparent over at least the entire height, respectively, of the concave conical surface (3, 13). The protective housing (7, 17) furthermore comprises means for attachment to the image sensor (4) in a lighttight manner. These attachment means are, for example, constituted by a screw thread.

In the embodiment shown in FIG. 10, the order 1 transmitting surfaces (11, 21) are positioned at the bottom of the housings (7, 17) and the order 2 transmitting surfaces (22, 32) are positioned in another housing (23) integral with the housings (7, 17) and which can be made integral with the image sensor (4).

In the embodiment shown in FIG. 11, the transmitting surfaces (11, 21) are positioned in a housing (23) which is integral with the housings (7, 17) and which can be made integral with the image sensor (4).

As can be seen, the visual fields (5, 15) respectively of the primary reflector (2) and the secondary reflector (12) are not identical in the different versions. Selection among the different versions is therefore implemented as a function of the desired fields of vision.

The invention also pertains to an image sensor (4) provided with a device (1), to a process for constructing a digital image by acquisition of a panoramic anamorphic image by means of a device (1) and by digital processing of said image, as well as to a digital image obtained by implementation of the device (1).

An example of mathematical determination of the dimensions of the base version of the device (1) is presented below to provide better comprehension of the invention:

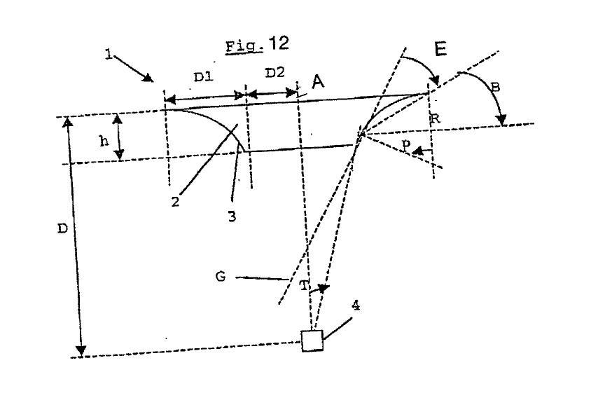

To simplify the mathematical determination of the dimensions of the conical surface (3), we will take the case in which the curve of this concave conical form is the arc of a circle. The dimensions of the system depend on several variables which are enumerated with reference to FIG. 12:

D is the distance between the objective of the image sensor (4) and the top of the primary reflector (2);

T is the visual angle on the primary reflector (2) from the objective of the image sensor (4);

P is the angle describing the arc of a circle in which is inscribed the curve of the primary surface (3);

R is the radius of the circle characterizing the arc of a circle;

E is the angle of reflection of the image;

G is the tangent to the circle;

Pmax is the value of the angle P for the complete arc of a circle;

Tmin is the value of the angle T for P=Pmax;

B is the value of the angle for which the image sensor (4) sees highest;

h is the height of the form.

Determination of the distance D is performed as a function of the focal length of the objective, knowing that this focal length represents an angle (for example, 38 mm in 4/3 equivalent to an angle of 38 degrees on the horizontal plane).

In order for the surface (3) to be viewed in its entirety by the objective, it is necessary that:

D=(D1+D2)/tan (angle of the focal length).

The determination of the angle Pmax such that the lower end of the form does not reflect the top end is then such that:

Bmax=2Pmax−Pi/2+Tmin.

Given that for the case in which said conical surface (3) is generated by a generator which is essentially the arc of a circle:

Bmax=Pmax/2m,

we have:

Pmax/2=2Pmax−Pi/2+Tmin

Pmax=−2(Tmin−Pi/2)/3.

Thus, the radius R is:

R=D2/(cos (Pi/2−Pmax)),

and the height h:

h=R(1−Sin(Pi/2−Pmax)).

The device (1) determined in this manner enables acquisition of panoramic images.

Thus, this invention displaces the point of origin of the visual angle from the proximal end of the reflector means towards its distal end, implementing the surface of said primary conical concave reflector.

According to the variants of the invention, primary conical surface is generated by an essentially parabolic generator or by a generator which is essentially the arc of a circle or by an essentially elliptical generator. The resultant image, whether it be taken with a photographic or a video camera, is a two-dimensional anamorphic image which can recreate a complete panorama over 360° with a three-dimensional effect.

By means of the device according to the invention, the average visual field is closer to the horizontal and it is possible to obtain images very close to natural human vision.

In one version of the invention, said reflector means presents the form of a cone that has a base with a return so that it is possible to capture the visual field located behind the image sensor. The reflector can moreover be in the form of a cone with a truncated vertex to allow positioning an attachment element on said vertex.

In a preferred embodiment, the reflector is primary and has the form of a cone with a recessed vertex and the image acquisition device comprises at least one transmitting surface, which is at least partially reflective, thereby enabling transmission of the image towards the image sensor, for example, through the recessed vertex.

This version presents furthermore a variant in which the image acquisition device comprises a secondary reflector provided with an outer secondary surface having the form of a cone, which is at least partially reflective and concave, and which is coaxial with the primary reflector means. The secondary reflector preferably has the form of a cone the secondary vertex of which is truncated and possibly recessed to allow passage of the image. Different versions can, thus, be derived from these base versions as a function of the desired fields of vision, and more specifically as a function of the general orientation of the desired image.

The device according to aspects of the invention advantageously does not reflect the image sensor and it makes it possible to obtain a complete visual field. The device according to aspects of the invention advantageously makes it possible to obtain a maximal image quality in the zone of the environment containing the most information, i.e., the zone close to the horizontal. Furthermore, the device according to aspects of the invention makes it possible to place the reflective surface(s) in a protective device positioned outside of the visual field of the image acquisition device.

As a result of the pertinence of the visual field obtained with the device according to the invention, it can be used for very specific applications, such as, for example, the qualitative and quantitative measurement of certain waves in spectral measurement devices, especially for the analysis of the composition of materials.

The invention also pertains to an image sensor provided with an image acquisition device according to the invention, to a process for the construction of a digital image by acquisition of a panoramic anamorphic image by means of an image acquisition device according to the invention as well as to a digital image obtained by implementation of the image acquisition device according to the invention.

1. A panoramic image acquisition device comprising at least one primary reflector provided with an outer primary surface which is at least partially reflective to reflect an image towards at least one image sensor, wherein the primary reflector has a concave conical primary surface.

2. The device according to claim 1, wherein the conical primary surface is generated by an essentially parabolic generator.

3. The device according to claim 1, wherein the conical primary surface is generated by a generator which is essentially the arc of a circle.

4. The device according to claim 1, wherein the conical primary surface is generated by an essentially elliptical generator.

5. The device according to claim 1, wherein the primary reflector has a conical form which has a base having a return.

6. The device according to claim 1, wherein the primary reflector has a conical form which has a truncated vertex.

7. The device according to claim 6, wherein the primary reflector has a conical form which has a recessed vertex.

8. The device according to claim 6, further comprising an attachment element located at the level of said vertex.

9. The device according to claim 1, further comprising at least one transmitting surface which is at least partially reflective.

10. The device according to claim 1, further comprising a secondary reflector provided with an outer secondary surface and having a conical form which is at least partially reflective and concave, essentially coaxial with the primary reflector.

11. The device according to claim 10, wherein the secondary reflector has a conical form whose secondary vertex is truncated.

12. The device according to claim 11, wherein the secondary reflector has a conical form whose secondary vertex is recessed.

13. The device according to claim 10, wherein the primary reflector and said secondary reflector are positioned back to back.

14. The device according to claim 10, wherein the primary reflector and said secondary reflector are positioned face to face.

15. The device according to claim 10, wherein the image sensor is positioned between the primary reflector and the secondary reflector.

16. The device according to claim 10, wherein the primary and/or secondary reflectors is (are) located in a protective housing having at least one window which is at least partially transparent over at least an entire height(s), respectively, of the conical surface(s).

17. The device according to claim 16, wherein the protective housing comprises means for attachment to the image sensor in a lighttight manner.

18. An image sensor provided with a device according to claim 1.

19. A process for constructing a digital image by acquisition of a panoramic anamorphic image by a device according to claim 1 and by digital processing of said image.

20. A digital image obtained by the device according to claim 1.
